(19) United States
(12) Patent Application Publication
(10) Pub. No.: US 2010/0248195 A1
(43) Pub. Date: Sep. 30, 2010

(54) APPARATUS AND METHOD FOR TEACHING TARGET SOUND PRODUCTION FOR SPEECH IN WORDS WHEN TARGET SOUND IS PART OF A CONSONANT BLEND

(76) Inventor: Cheri Fletcher, North Miami, FL (US)

Correspondence Address: LOTT & FRIEDLAND, P.A., P.O. BOX 141098, CORAL GABLES, FL, 33114-1098, US

(21) Appl. No.: 12/730,731

(22) Filed: Mar. 24, 2010

Related U.S. Application Data
(60) Provisional application No. 61/164,099, filed on Mar. 27, 2009.

(51) Int. Cl. G09B 19/04

(52) U.S. Cl. 434/185

(57) ABSTRACT

Disclosed is a method and complementary apparatus for teaching speech sound production of a target sound that is positioned within the consonant blend of a word in which the consonant blend is split at a precise point in order to focus the student's attention on the target sound to teach its proper pronunciation and in which the split consonant blend is distinguishably demarcated within the word and the word is presented to the student in and on a variety of suitable media.

### RELATED APPLICATIONS

This application claims the benefit of U.S. Provisional Application No. 61/164,099 filed Mar. 27, 2009.

### TECHNICAL FIELD

This invention relates generally to speech language pathology and specifically to a method and complementary apparatus utilized to teach problem error sound production to persons with speech articulation and/or language problems that present themselves with articulation errors.

### BACKGROUND OF THE INVENTION

Speech language pathology is concerned with the diagnosis and remediation of a variety of disorders that are related to speech and language problems. The present invention focuses particularly on teaching aids and a method incorporated in and on suitable mediums which is directed to the remediation of speech articulation problems or language problems that present themselves with articulation errors. The visual presentation of written letters in words aids in enhanced articulation of a problem sound or sounds, and phonological processing for the acquisition of correct sound production and sound sequencing in words. Therefore, viewing strategic positioning of letters and/or their highlighted elements in a word helps speech and language impaired students process for accurate sound production in words. Specifically, the disclosed method and aids are used in and on teaching materials to enhance speech sound production of problem consonant sounds, also referred throughout this disclosure as “target sounds”, that occur in a person's speech when the sound is positioned in a “consonant blend” (also called a “blend”) of a word. Additionally, the term “phoneme” is defined as a sound in a language that is understood to be distinct from the other sounds in that language.

For purposes of the present disclosure, a consonant blend is defined as a group of two or three consonant letters wherein each letter in the group retains its normal consonant sound and wherein there is no vowel sound between any of the consonant letters.

The present invention addresses only target sounds that occur in consonant blends and not consonant digraphs or trigraphs. Consonant blends differ from consonant digraphs and trigraphs in that each consonant letter in the consonant blend is distinctly heard whereas the same is not true for digraphs and trigraphs.

For example, in the word “spring”, the letters “spr” constitute a consonant blend because each of the letters in the group, “s”, “p” and “r” are distinctly heard when the word is properly spoken. On the other hand, in the word “ship”, the two letters “sh” form a consonant group but make only one sound when the word is properly spoken. Therefore, “sh” is a digraph; not a consonant blend.

Consonant digraphs consist of two consonant letters that make only one sound. These include, for example, the groups “sh”, “ch”, “ck”, “wh”, “ph” and “th”. Consonant trigraphs consist of three consonant letters that make only one sound, and include, for example, the group “tch.”

A consonant digraph could be a component of a consonant blend. If a consonant digraph is part of a consonant blend, it is treated as one sound in the blend. For example, in the word “shred”, there are two blend sounds, the “sh” and “r”. The “sh” is heard as one sound and the “r” is heard as another sound. Therefore, although there are three consonant letters grouped together, only two sounds are heard due to the fact that one of the sounds (“sh”) is a digraph.

Previous attempts have been made at perfecting methods for teaching proper sound production of a target sound within a consonant blend. The most common such method is referred to as “cued articulation.”

Cued articulation utilizes tactile (touch) cues or body motions to signal to the individual being taught (i.e., the “student”) a point of division within the target consonant blend. The target sound within the blend is signaled to the student by using gestures or touch to a body part (for example, to the arm or lips) at the appropriate moment as the word is being sounded by the individual doing the teaching (i.e., the “clinician.”) This makes the word sound as having two distinct parts.

For example, if the student is having a problem pronouncing the “s” sound and the “s” is part of a blend of a word (for example, “smile”), the clinician would show separation of the “sm” blend in the word by a physical gesture of either making an “s” with a finger in the air or running a finger down the student's arm or his/her own arm to designate the “s”, and then initiate the next word part by the clinician placing his/her finger to closed lips to indicate the “m” in “mile” which starts the next word part. With this example, the clinician says aloud the two word parts independently at the same moment that he/she presents the cued gestures. That is, saying “s” when the finger is sliding down the arm and then saying “mile” when the finger is placed to the lips.

The act of creating two separate word parts from splitting up a blend between the target sound and its adjacent consonant using cued gestures, paired with sounding the separate word parts, renders the target sound more prominent within the word. This allows the student to develop an awareness of the target sound in its blend position and provides the student with the support he or she needs to pronounce the target sound with greater ease.

Cued articulation is a very effective technique due to its consonant blend separation to target a sound, but its principal drawback is that it requires physical interaction and tactile feedback between the clinician and the student. There are teaching situations in which physical contact between the clinician and the student are not advisable or even possible. In these situations, cued articulation cannot be used and other, less effective, techniques are presently used.

One such known technique, hereinafter the “reading blends technique”, is a method to teach decoding of blends in words for reading skills. The reading blend is defined as a written consonant blend that is grouped together as one unit that separates it from the rest of its word to teach students how to decode blend consonants in words. The reading blends technique specifically involves teaching reading decoding skills with the presentation of written words with the demarcating of the entire consonant blend cluster separated from the rest of its word to the student. The reading blends technique lumps the entire blend group together through visual demarcations such as spacing, a different color, bolder print, underscoring, etc. For example, in the word “smoke”, the reading blends technique would lump “sm” together and the word would appear as “smoke”. Such method is presented on various materials such as flash cards, workbooks, computer software programs, board games, etc.

The reading blends technique is effective for teaching reading words, but not effective for teaching articulation or a phonological problem (i.e., a problem associated with phonemes of a language and the rules that govern their combination) of a sound that is part of a blend in a word. This reading blends technique is currently being used in and on speech therapy materials (such as workbooks, bingo games, board games, card games, flash cards, software programs, etc.), and does not provide the correct cueing system (showing blend separation to target a sound) for effective results with target sound acquisition that is part of a blend. People with sound production problems have much difficulty or unable to process and produce their problem sound in an entire blend with all the consonant letters clustered together as one unit. This is because their defective phonological system is unable to identify and discriminate the target consonant sound from its adjacent consonant sound in the blend of a word. Speech therapy materials presently used for workbooks, bingo games, board games, card games, flash cards, etc. borrow heavily from the reading blends technique by keeping the consonant cluster in the blend together that contains the target sound, which does not assist or clue the student to identify the target sound in its blend for processing and sound production. The speech and/or phonologically impaired student requires seeing the blend phonemes separated between the target consonant sound and its adjacent consonant so that the target sound is clearly distinguished from its adjacent consonant in a word. Whereas the student learning to read (who is not targeting an articulation or phonological error sound), requires seeing the entire cluster of blend letters grouped together to enhance reading decoding skills.

The following show examples on how the reading blends technique differs from the present invention. With the reading blends technique, using the word “frog” with “R” as the target sound, a representation of the blend (“FR”) is set apart from the rest of its word (“OG”) and would appear as FR OG. The present invention shows the example word “frog” with the target sound “R” presented as F-ROG. With the present invention, the blend is separated between the target sound “R” and its adjacent consonant “F”. The “R” is distinctly identified and emphasized by presenting as the beginning sound of the second word part. Whereas with the reading blends technique, the “R” holds equal emphasis in its blend unit, in which the “R” does not stand out to be distinct from its adjacent consonant for easy identification, and is therefore, ineffective for teaching speech production of a problem consonant sound that is part of a blend to speech and/or phonologically impaired persons.

Another similar technique, hereinafter the “rebus cue card technique”, also involves the use of cue cards or flash cards. However, instead of a purely textual representation of a word containing a target sound, the cue card provides a representation in which a portion of the word is shown as text and a portion is shown as an illustration. When the two portions are sounded out, the complete word is spoken.

For example, using this technique the word “spill” would be represented by the letter “S” and an illustration of a medicine capsule (i.e., to represent a “pill”) and would appear as: S+(picture of a pill). Again, the objective is to force the student to focus on the problem sound, the “S”, by separating the blend containing it from the rest of the word.

The rebus cue card technique has its deficiencies for effective teaching articulation of target sounds in blends. Using this technique, the clinician has almost no flexibility in deciding whether the target sound will be worded at the beginning, end, or middle of the word part that the target sound is included within.

Moreover, the rebus cue card technique is further limited in that there is a finite number of potential graphical depictions that correspond to word portions. As a result, certain words, consonant blends and target sounds are impossible to be correctly taught using the rebus cue card technique. For example, for words like “snake”, “blonde”, and “broken”, having the target sound in a blend (i.e.; “S” in snake, “L” in blonde, and “R” in broken), cannot be taught using the rebus cue card technique. The rebus cue card technique would have to display: S+picture of a “nake” (for snake), B+picture of a “londe” (for blonde), and B+picture of a “roken” (for broken). There is no semantic meaning for “nake”, “londe”, or “roken”, and therefore, there is no available illustration to use as part of a rebus.

Yet there is a “sound separation method” for teaching a target sound in a word by displaying the separation of the target sound from the rest of its word that does not discriminate as to where the point of separation occurs from the target sound. With this method, blend separation to target a phoneme (sound) is not the objective as it is with the present invention, and because of this, the sound separation method has many instances where the target sound is shown grouped together like a “reading blend”. This is observed with the method's written words containing the “R” Blends to target the “R” sound (e.g.; cr-y for “cry”), and with words containing a target consonant in a blend that is positioned at the end of a word (e.g.; mo-ps for “mops”). With the final blends (blends at the end position of words) using this method, the separation is before the blend to separate the target sound from the rest of the word, keeping all the consonant letters grouped together like a “reading blend”. For example, with the word “mops” and the target sound is “p”, the word shows as mo-ps. This separation is before the “p” to separate it from the word, thus keeping the blend together as one unit as opposed to the present invention that would separate the blend between its two adjacent consonants “p” and “s” to target the “p”. With targeting the “R” sound in a blend using this method, the separation is before the “R” such that all the consonant letters in this blend remain clustered together. By separating the “R” along with its adjacent consonants, places equal emphasis on the “R” in its blend unit, such that the “R” does not stand out as distinct for processing speech sound production. For example, using the word “cry”, with the target sound “R” in the “cr” blend shows as cr-y. The “cr” blend remains together as one unit and not separated. The deficiency with this method is that there are several instances where the target sound cannot be obviously identified for sound processing and speech production due to keeping the blend together as one unit.

Accordingly, there is presently a need in the art for a method for teaching speech sound production of a target sound that is positioned within the consonant blend of a word, wherein such method does not require any physical contact between the student and clinician.

There is a further need in the art for a method for teaching speech sound production of a target sound that is positioned within the consonant blend of a word, wherein such method does not require the student to observe any gestures or other visual cues performed by the clinician.

There is a further need in the art for a method for teaching speech sound production of a target sound that is positioned within the consonant blend of a word, wherein such method utilizes any suitable materials or medium such as cue cards, card games, board games, bingo games, workbooks, story books, computer phonics software, etc. that precisely focuses the student's attention on the target sound.

There is a further need in the art for a method for teaching speech sound production of a target sound that is positioned within the consonant blend of a word, wherein such method utilizes suitable media or materials to depict the word being taught in written form only and allows for the focus of attention to be placed on the target sound within the consonant blend.

### SUMMARY OF THE INVENTION

The subject invention resolves the above-described needs and problems by providing a method for teaching speech sound production of a target sound that is positioned within the consonant blend of a word in which various forms of suitable media, such as cue cards, card games, board games, workbooks, bingo games, puzzles, software programs, etc. are used to present the word being taught, and in which the consonant blend in question is separated at a precise point in order to focus the student's attention on the target sound to teach its proper pronunciation.

In the method of the present invention, the word being taught is separated in its blend between the precise point that the target sound is made and its adjacent consonant, which causes the word to separate as two word parts. This separation is clearly identified by demarcations to show the two word parts. Demarcations for word part separations are indicated in various ways. The separation of the two word parts may be shown by use of a space, a hyphen, color differences, bolding, italicizing, or other marks about the word part(s) such as underscoring, boxing around a letter or letters, etc. By displaying conspicuous demarcations to show the separation of the two word parts between the target sound and its adjacent consonant in a blend, the target sound is able to stand out so that the student's focus is directed with precision to the targeted sound.

In different embodiments of the present invention, the split blend in a word may be presented to the student on any suitable medium including: a computer screen by means of software running on a general purpose computer, DVD or video tape, electronic devices that display letters and/or words, workbooks, books, magazines, game boards, flash cards, cue cards, card games, story books, puzzles, stamps, adhesive materials (i.e.; stickers, labels, tattoos, magnets), and any other media that may accommodate written words.

Accordingly, it is an object of the present invention to provide a method for teaching speech sound production of a target sound that is positioned within the consonant blend of a word, wherein such method does not require any physical contact between the student and clinician.

It is an additional object of the present invention to provide a method for teaching speech sound production of a target sound that is positioned within the consonant blend of a word, wherein such method does not require the student to observe any gestures or other visual cues performed by the clinician.

It is an additional object of the present invention to provide a method for teaching speech sound production of a target sound that is positioned within the consonant blend of a word, wherein such method utilizes any suitable medium such as game cards, game boards, flash cards, etc. that precisely focuses the student's attention on the target sound.

It is an additional object of the present invention to provide a method for teaching speech sound production of a target sound that is positioned within the consonant blend of a word, wherein such method utilizes any suitable medium that depicts the word being taught in written form only and allows for the focus of attention to be placed on the target sound that occurs anywhere within the consonant blend.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a flowchart showing the steps utilized to implement the disclosed method to teach a target consonant sound that is part of a consonant blend to a student.

FIG. 2 is a composite illustration showing cue cards for words split in accordance with the disclosed method and in which the split has been demarcated in a variety of exemplary ways.

FIG. 3 shows a bingo board that embodies the consonant blend splitting method of the present invention.

### DETAILED DESCRIPTION OF THE PREFERRED EMBODIMENT

While the present invention will be described more fully hereinafter with reference to the accompanying drawings, in which a preferred embodiment of the present invention is shown, it is to be understood at the outset of the description which follows that persons of ordinary skill in the relevant arts may modify the invention herein described while still achieving the favorable results of this invention. Accordingly, the description which follows is to be understood as being a broad, teaching disclosure directed to persons of skill in the appropriate arts, and not as limiting upon the present invention.

The present disclosure describes a method for teaching speech sound production of a target consonant sound that is positioned within the consonant blend of a word by: (a) splitting or separating the blend at a precise point between the target sound and its adjacent consonant such that the word separates into two word parts; and (b) displaying the split word to the student so as to focus the student's attention on the target consonant sound to teach its correct pronunciation.

In the present invention, the word being taught to the student is separated at the precise point between the target consonant sound and its adjacent consonant. Depending on the location and type of target sound within the word, once the word is separated, the target sound will be located either in the first word part, or the target sound will appear at the beginning of the second word part.

Further, after the word is separated, the separation is displayed through one or more known demarcation methods. These methods include, for example: (a) highlighting a word part in a different color from the other word part; (b) highlighting a word part in a different font (e.g.; italics, bold, size, etc.) from the other word part; (c) underscoring a word part or word parts separate from one another; (d) utilizing uppercase and/or lowercase letters for different word parts; (e) introducing spacing between word parts; (f) outlining a word part or both word parts separate from one another with a geometric shape; (g) changing the background color for a word part or word parts separate from one another; (h) hyphenating between word parts; (i) placing marks (such as bullet dots, lines, or checks) anywhere around the word part or word parts to separate word parts; and (j) combinations of any of the above to show word part separation.

It has been demonstrated in practice that by presenting to a student a blend in a word that has been split between the target consonant sound and its adjacent consonant and the resulting word parts demarcated in the manner above, the student's focus is immediately drawn to the target sound and it is, therefore, much easier for the student to process and be taught the target sound.

Determining where the split in the consonant blend should occur depends on where the target sound is positioned within the blend. If the target consonant sound occurs at the beginning of the blend, then the separation is placed immediately after the letter representing the target sound. If the target consonant sound occurs in the middle or at the end of the blend, then the separation is placed immediately before the letter or letters representing the target sound. The above rules hold true regardless of where within the word the consonant blend is located.

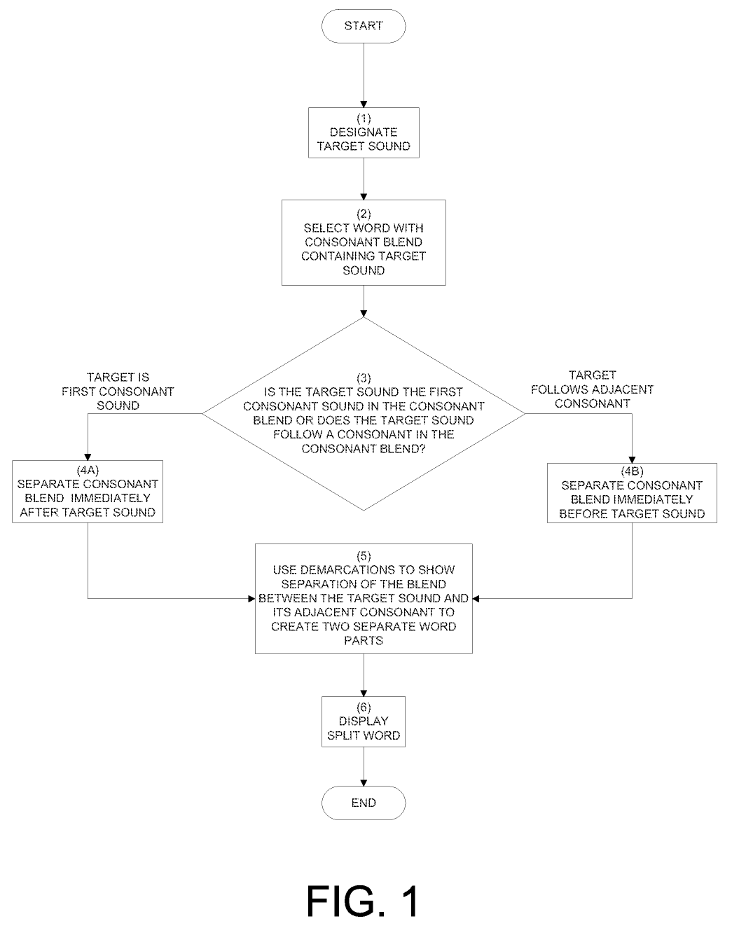

Referring to FIG. 1, depicted is a flowchart showing the steps utilized to implement the disclosed method to teach a target sound to a student. In step (1) the target sound is designated by the clinician based on his or her evaluation of the student. Next, in step (2) a word that contains the target consonant sound within a consonant blend is selected. According to step (3), if the target consonant sound is found at the beginning of the consonant blend, then in step (4a) the word is separated into two parts so that the split occurs immediately after the target consonant sound within its blend. If, on the other hand, the target consonant sound occurs after its adjacent consonant then according to step (4b) the word is separated into two word parts so that the split occurs immediately before the target sound in the consonant blend. Next, in step (5), demarcations are used to display the separation of the two word parts in the word such as spacing or hyphenating between the word parts, or having one or both word parts of the separated word highlighted to be differentiated from one another. In the final step (6), the separated word with its demarcation is displayed to the student.

It should be understood that in the embodiment described in FIG. 1, the clinician can create teaching materials on suitable media such as the following but not limited to: board games, matching card games, standard card games (E.g.; Go Fish, Memory, Uno, War, Old Maid, etc. . . . ), bingo games, Tic-Tac-Toe Games, game toys (e.g.; puzzles), typing devices, electronic games, electronic devices, video demonstrations, software programs, written drill practices, stamps, self-adhesive materials (e.g.; tattoos, stickers, labels, etc.), books, literature items (e.g.; stories, demonstration materials, magazines, etc.), cue cards, flash cards, banners, labels, paper activities (e.g.; workbooks and word lists, sentence strips, etc.), barrier task materials, and the like, to be written or read on containing separated words having demarcations to indicate the split at the appropriate juncture between the target consonant sound and its adjacent consonant in the blend that designates two word parts from the split of the blend. Similarly, games, puzzles, stories, workbooks, interactive activities, drill practices, labels, stickers, banners, and cue cards and other paper materials may be created using a general purpose computer attached to a printer as well as other electronic devices (such as DVD or video tape presentations and activities, CD's, overhead projectors, etc.) incorporating the method of the present invention.

It is also envisioned that the disclosed method may be implemented with a set of pre-printed materials (such as word lists, cue cards, puzzles, etc. . . . ) that are adapted to display the most common target sounds at various positions within a consonant blend of a word with the word shown separated into its two word parts accordingly. Such pre-printed materials may be prepared by the clinician or sold commercially by third parties. In such an embodiment, steps (2) through (5) in FIG. 1 would be replaced by selecting an appropriate item from the aforementioned set of pre-printed materials.

It should also be noted that in lieu of printed materials, the disclosed method can easily be implemented through a monitor or other display connected to a general purpose computer that has been programmed to perform steps (2) through (6) in FIG. 1 after selection of a target sound or sounds by the clinician.

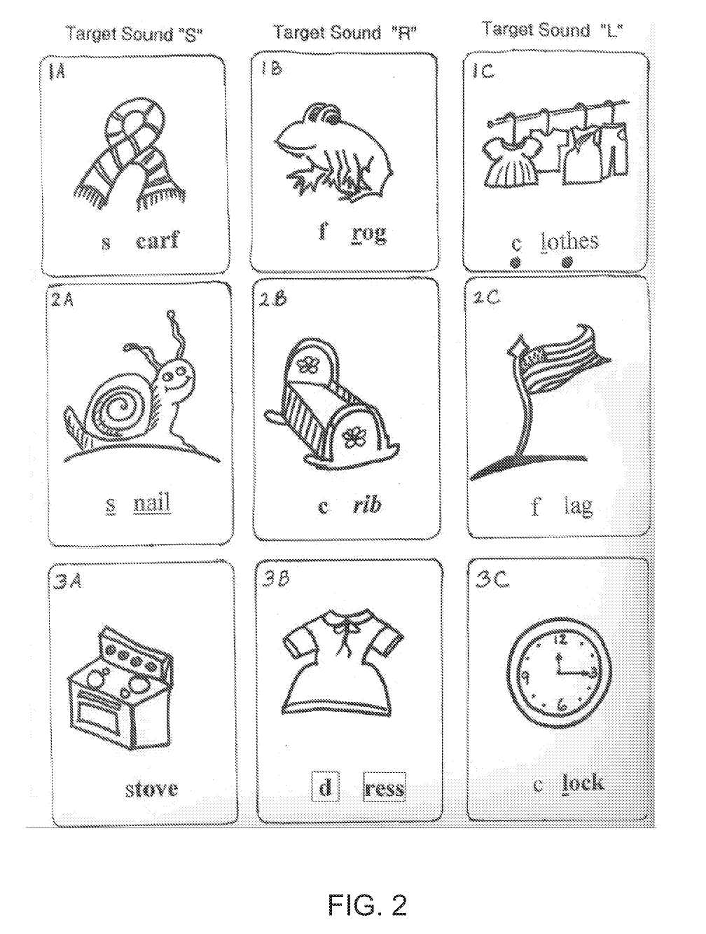

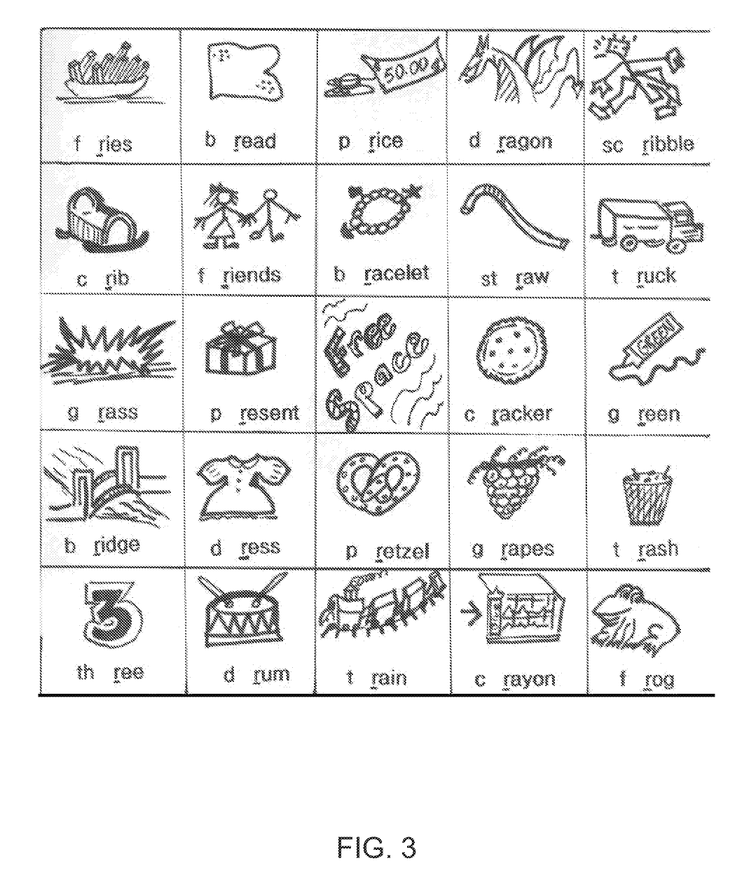

Referring to FIG. 2, depicted are cue cards for words split in accordance with the disclosed method and in which the split has been demarcated in a variety of ways. FIG. 3 is a bingo board that embodies the consonant blend splitting method of the present invention. The illustrated demarcation methods to show separation of blends are exemplary in nature and not intended to be limiting. It should be noted that in FIGS. 2 and 3 in certain instances different colored text has been used to demarcate consonant blend splits. For example, in the cue card labeled “3A” in FIG. 2, the letter “S” is red while the letters “TOVE” are black. Due to technical limitations in the patent application process, color illustrations cannot be submitted and therefore the color variations are not clearly visible.

For purposes of clarity, following are examples of words that have been split based on the above mentioned rules. The examples depict words in which consonant blends occur at the beginning, middle, or end of the word, and in which the target sound is located at the beginning, middle, or end of the consonant blend. For purposes of these examples, the method for demarcating the split is a double dash (“--”). It is understood, however that many other demarcation methods, as discussed above, may be utilized.

### Example 1

Word is “street”; consonant blend (“str”) located at beginning of word; target sound (“s”) located at beginning of consonant blend:

Split word: S--TREET

### Example 2

Word is “street”; consonant blend (“str”) located at beginning of word; target sound (“t”) located at middle of consonant blend:

Split word: S--TREET

### Example 3

Word is “street”; consonant blend (“str”) located at beginning of word; target sound (“r”) located at end of consonant blend:

Split word: ST--REET

### Example 4

Word is “destroy”; consonant blend (“str”) located at middle of word; target sound (“s”) located at beginning of consonant blend:

Split word: DES--TROY

### Example 5

Word is “destroy”; consonant blend (“str”) located at middle of word; target sound (“t”) located at middle of consonant blend:

Split word: DES--TROY

### Example 6

Word is “destroy”; consonant blend (“str”) located at middle of word; target sound (“r”) located at end of consonant blend:

Split word: DEST--ROY

### Example 7

Word is “bands”, consonant blend (“nds”) located at end of word; target sound (“n”) located at beginning of consonant blend:

Split word: BAN--DS

### Example 8

Word is “bands”; consonant blend (“nds”) located at end of word; target sound (“d”) located at middle of consonant blend:

Split word: BAN--DS

### Example 9

Word is “bands”; consonant blend (“nds”) located at end of word; target sound (“s”) located at end of consonant blend:

Split word: BAND--S

Accordingly, it will be understood that the preferred embodiment of the present invention has been disclosed by way of example and that other modifications and alterations may occur to those skilled in the art without departing from the scope and spirit of the appended claims.

I claim:

1. A method of speech language therapy for teaching a target consonant sound that is part of a consonant blend to a student, comprising the steps of:
a) designating said target consonant sound, wherein said target sound is represented by one or more letters;
b) selecting a word having a consonant blend that contains said target consonant sound;
c) if said target consonant sound is located at the beginning of said consonant blend, splitting said word into a first part and a second part immediately after said target sound; otherwise, splitting said word into said first part and said second part immediately before said target sound;
d) demarcating said word to differentiate said first part from said second part;
e) displaying said word, including said first part, said second part, and said demarcation, to said student.

2. The method of claim 1 whereby said word is displayed to said student on media, wherein said media is selected from the group consisting of: paper, board games, card games, bingo games, tic-tac-toe games, puzzles, electronic games, video, computer screens, stamps, stickers, labels, books, cue cards, flash cards, banners, work books, barrier task materials, and combinations thereof.

3. The method of claim 1 whereby said step of demarcating said word is further characterized by highlighting said first part or a portion thereof in a different color than said second part or a portion thereof.

4. The method of claim 1 whereby said step of demarcating said word is further characterized by inserting a space between said first part and said second part.

5. The method of claim 1 whereby said step of demarcating said word is further characterized by inserting a hyphen between said first part and said second part.

6. The method of claim 1 whereby said step of demarcating said word is further characterized by underlining said first part or a portion thereof.

7. The method of claim 1 whereby said step of demarcating said word is further characterized by underlining said second part or a portion thereof.

8. The method of claim 1 whereby said step of demarcating said word is further characterized by underlining said first part and said second part independently of each other.

9. The method of claim 1 whereby said step of demarcating said word is further characterized by varying the case lettering of said first part or a portion thereof in relation to the case lettering of said second part or a portion thereof.

10. The method of claim 1 whereby said step of demarcating said word is further characterized by varying the style of said first part or a portion thereof in relation to the style of said second part or a portion thereof, wherein said style comprises the font size, shape, color, and orientation thereof.

11. The method of claim 1 whereby said step of demarcating said word is further characterized by outlining said first part or a portion thereof with a geometric shape, wherein said geometric shape is selected from the group consisting of a square, a rectangle, a circle, an oval, a triangle, a polygon, and combinations thereof.

12. The method of claim 1 whereby said step of demarcating said word is further characterized by outlining said second part or a portion thereof with a geometric shape, wherein said geometric shape is selected from the group consisting of a square, a rectangle, a circle, an oval, a triangle, a polygon, and combinations thereof.

13. The method of claim 1 whereby said step of demarcating said word is further characterized by outlining said first part or a portion thereof and said second part or a portion thereof with a geometric shape independent of one another, wherein said geometric shape is selected from the group consisting of a square, a rectangle, a circle, an oval, a triangle, a polygon, and combinations thereof.

14. The method of claim 1 whereby said step of demarcating said word is further characterized by placing marks anywhere around said first part or a portion thereof, wherein said marks include dots, lines, checks, and asterisks.

15. The method of claim 1 whereby said step of demarcating said word is further characterized by placing marks anywhere around said second part or a portion thereof, wherein said marks include dots, lines, checks, and asterisks.

16. The method of claim 1 whereby said step of demarcating said word is further characterized by independently placing marks anywhere around said first part or a portion thereof and said second part or a portion thereof, wherein said marks include dots, lines, checks, and asterisks.

17. The method of claim 1 whereby said step of demarcating said word is further characterized varying the background color or shading of said first part or a portion thereof, in relation to the background color or shading of said second part or a portion thereof.

18. The method of claim 1 whereby said step of demarcating said word is further characterized varying the background color or shading of said second part or a portion thereof, in relation to the background color or shading of said first part or a portion thereof.

19. The method of claim 1 whereby said step of demarcating said word is further characterized varying the background color or shading of said first part or a portion thereof and the background color or shading of said second part or a portion thereof wherein said background colors or shadings for said first part and said second part are different.

20. The method of claim 1 wherein said steps are performed through computer software.
